(19) United States
(12) Patent Application Publication
(10) Pub. No.: US 2013/0300651 A1
(43) Pub. Date: Nov. 14, 2013

(54) APPARATUS AND METHOD FOR CONTROLLING ELECTRONIC DEVICE

(71) Applicant: Toshiba Samsung Storage Technology Korea Corporation, (US)

(72) Inventor: Dong-Hwan LIM, Yongin-si (KR)

(73) Assignee: Toshiba Samsung Storage Technology Korea Corporation, Suwon-si (KR)

(21) Appl. No.: 13/889,422

(22) Filed: May 8, 2013

(30) Foreign Application Priority Data
May 8, 2012 (KR) 10-2012-0048777

(51) Int. Cl. G06F 3/01

(52) U.S. Cl. CPC G06F 3/017
USPC 345/156

(57) ABSTRACT

Provided are an apparatus and method for controlling an electronic device. The apparatus includes a plurality of sensors to detect manipulation by a user, a control unit to recognize a motion pattern based on the user manipulations detected by the plurality of sensors and to determine an operation to be executed in accordance with the recognized user's motion pattern, and a transmitting unit to transmit a digital signal for an electronic device to execute the operation determined by the control unit.

### CROSS-REFERENCE TO RELATED APPLICATION(S)

This application claims the benefit under 35 U.S.C. §119(a) of Korean Patent Application No. 10-2012-0048777, filed on May 8, 2012, in the Korean Intellectual Property Office, the entire disclosure of which is hereby incorporated by reference for all purposes.

### BACKGROUND

1. Field

The following description relates to a user interface for controlling an electronic device in accordance with a user's manipulation.

2. Description of the Related Art

There are various types of control apparatuses that enable users to control an input to an electronic device. For example, the control apparatuses may include a remote control with mechanical buttons that are limited in space to include the necessary buttons for controlling diversified functions of an electronic device. If the remote were to include less number of buttons, it becomes difficult to represent all necessary instructions to control an electronic device, whereas too many buttons may confuse and distract a user.

A remote control with a small touch screen showing a limited number of graphic user interface (GUI) elements has been proposed. Such a remote allows a user to input an instruction by touching desired displayed GUI elements. However, this remote control may be somewhat inconvenient to use because it assigns more than one instruction to each GUI element that is displayed on the same screen page, or arranges the GUI elements on a series of display pages. Accordingly, the user needs to touch the GUI elements several times while moving the screen back and forth. In addition, this type of remote control is especially inconvenient when the user inputs an instruction while watching TV because the user is required to focus their attention on the display of the remote control instead of a display of the TV to find a relevant button or GUI element.

Another proposed remote control includes a touch input device or a track ball. Using this remote control, a user can select a desired GUI element from among items displayed on a monitor of an electronic device and execute a relevant instruction. The remote control transmits location information or movement information of a screen pointer to the electronic device, thereby enabling a screen pointer on the electronic device's monitor to move. However, this method requires the user to continuously watch the location and movement of the screen pointer.

### SUMMARY

In an aspect, there is provided an apparatus for controlling an electronic device, the apparatus including a plurality of sensors configured to detect manipulation by a user, a control unit configured to recognize a motion pattern based on the manipulations of the user detected by the plurality of sensors and determine an operation to be executed based on the recognized motion pattern, and a transmitting unit configured to transmit a digital signal to the electronic device to control the electronic device to execute the operation determined by the control unit.

The plurality of sensors may be arranged at a touch area of the apparatus in which a light emitting element and a light receiving element are integrated with each other.

The plurality of sensors may be configured to detect the manipulation of the user based on radio frequency (RF) signals transmitted between an RF signal transmitter and an RF signal receiver.

The plurality of sensors may be motion detection sensors.

The plurality of sensors may be gravity sensors.

The plurality of sensors may be located at a left, a right, a top, a bottom, and a central portion of a predefined area on a surface of the apparatus.

The control unit may be configured to confirm which sensors from among the plurality of sensors detect the manipulation of the user, obtain location values of the sensors that confirm detection of the manipulation of the user, recognize the motion pattern of the user based on the location values of the sensors that confirm detection of the manipulation, and determine the operation to be executed from among predetermined operations based on the recognized motion pattern.

The control unit may be configured to sequentially arrange the location values of the is sensors that confirm detection of the manipulation in an order of a first to last sensor to detect the manipulation, search for a motion pattern that matches with the order of the arranged location values of the sensors by comparing the order of arranged location values of the sensors and predefined motion patterns, and select a corresponding motion pattern.

The control unit may be configured to determine the operation to be executed is fast forwarding towards an end of content or playing back final content, in response to the corresponding motion pattern being “ [symbol] .”

The control unit may be configured to determine the operation to be executed is rewinding towards a beginning of content or playing back first content, in response to the corresponding motion pattern being “ [symbol] .”

The control unit may be configured to determine the operation to be executed is fast forwarding current content or playing back next content, in response to the corresponding motion pattern being “—” in a right-hand direction.

The control unit may be configured to determine the operation to be executed is rewinding current content or playing back previous content in response to a user's recognized motion pattern being “—” in a left-hand direction.

The control unit may be configured to determine the operation to be executed as turning a volume or a channel up, in response to the corresponding motion pattern being “ [symbol] .”

The control unit may be configured to determine the operation to be executed as turning a volume or a channel down, in response the corresponding motion pattern being “ [symbol] .”

In an aspect, there is provided an apparatus for controlling an electronic device, the apparatus including a plurality of sensors configured to detect manipulation of a user, a control unit configured to recognize a motion pattern based on the manipulation of the user detected by the plurality of sensors and determine an operation to be executed based on the recognized is motion pattern, and an operation executing unit configured to execute the operation determined by the control unit.

In an aspect, there is provided a method of controlling an electronic device, the method including detecting manipulation of a user using a plurality of sensors, recognizing a motion pattern based on the manipulation of the user detected by the plurality of sensors, determining an operation to be executed based on the recognized motion pattern, and transmitting a digital signal to an electronic device to control the electronic device to execute the determined operation.

The determining may comprise confirming which sensors from among the plurality of sensors detect the manipulation by the user, obtaining location values of the sensors that confirm detection of the manipulation, recognizing the motion pattern of the user based on the location values of the sensors that confirm detection of the manipulation, and determining the operation to be executed from among predetermined operations based on the recognized motion pattern.

The recognizing of the motion pattern may comprise checking whether a number of obtained location values of the sensors that confirm detection of the manipulation is greater than a predetermined value, and in response to the number of obtained location values being greater than the predetermined value, recognizing the motion pattern based on the obtained location values of the sensors.

The recognizing of the motion pattern may comprise sequentially arranging the location values of the sensors that confirm detection of the manipulation in an order of a first sensor to a last sensor to detect the manipulation, and searching for a motion pattern that matches with an order of the arranged location values of the sensors by comparing the order of arranged location values of the sensors and predefined motion patterns associated with orders of location values of the sensors and selecting a corresponding motion pattern.

Other features and aspects will be apparent from the following detailed description, the drawings, and the claims.

### BRIEF DESCRIPTION OF THE DRAWINGS

FIG. 1 is a diagram illustrating an example of an apparatus for controlling an electronic device.

FIG. 2 is a diagram illustrating another example of an apparatus for controlling an electronic device.

FIG. 3 is a diagram illustrating an example of an exterior of the apparatus 2a of FIG. 1.

FIG. 4 is a diagram illustrating an example of an exterior of the apparatus 2b of FIG. 2.

FIG. 5 is a diagram illustrating in an example of the apparatus 2a of FIG. 1.

FIG. 6 is a diagram illustrating in an example of the apparatus 2b of FIG. 2.

FIG. 7 is a diagram illustrating an example of a sensor using light.

FIG. 8 is a diagram illustrating an example of a sensor using a radio frequency (RF) signal.

FIG. 9 is a diagram illustrating an example of a plurality of sensors.

FIG. 10 is a diagram illustrating an example of a method of an apparatus for controlling an electronic device.

FIG. 11 is a table illustrating examples of a user's motion patterns recognized based on user manipulations detected by a plurality of sensors of an apparatus for controlling an electronic device and operations corresponding to the motion patterns.

FIGS. 12A to 12F are diagrams illustrating examples of the user's motion patterns associated with location values of the sensor according to the table shown in FIG. 11.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

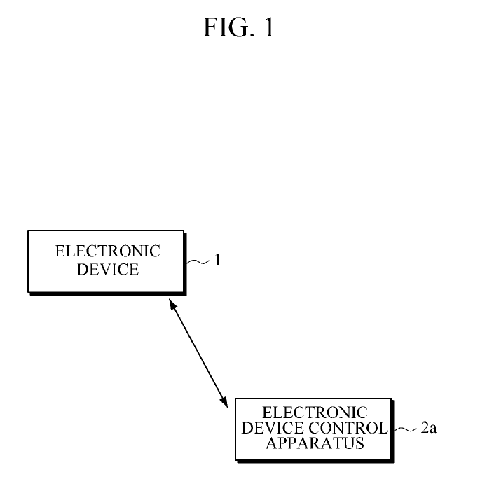

FIG. 1 illustrates an example of an apparatus for controlling an electronic device.

Referring to FIG. 1, an apparatus 2a may receive an input from a user to control an electronic device 1. The electronic device 1 may include any types of devices capable of reproducing images or sounds, for example, a television, a video game console, a Blu-ray player, a terminal, a computer, an appliance and the like. The electronic device 1 may provide users with sound, text, image, video and/or multimedia content. The apparatus 2a may provide various input functions for the users to use a given type of multimedia content, such as pictures and videos. The apparatus 2a may detect a user manipulation detected by a sensor as an instruction. Accordingly, the apparatus 2a may control the electronic device 1 to execute a predetermined operation in response to the instruction.

For example, while the user is viewing pictures through the electronic device 1, the user may be capable of viewing a previously viewed picture or the next picture by use of a manipulation detected by a sensor equipped in the apparatus 2a. As another example, while watching a video on the electronic device 1, the user may use the sensor of the apparatus 2a to control the video to fast-forward or pause.

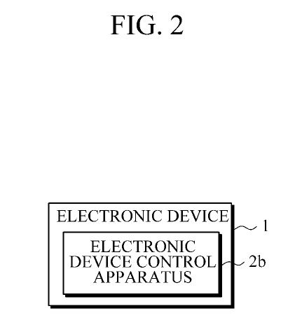

FIG. 2 illustrates another example of an apparatus for controlling an electronic device.

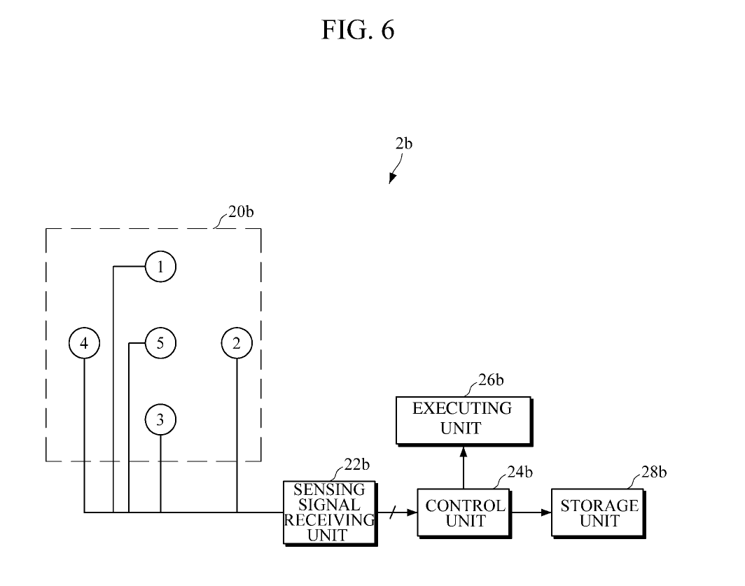

In this example, an apparatus 2b for controlling an electronic device is equipped in an electronic device 1. The operation and configuration of the apparatus 2b may be the same as or similar to those of the apparatus 2a of FIG. 1. Examples of the apparatus 2b are described with reference to FIG. 6.

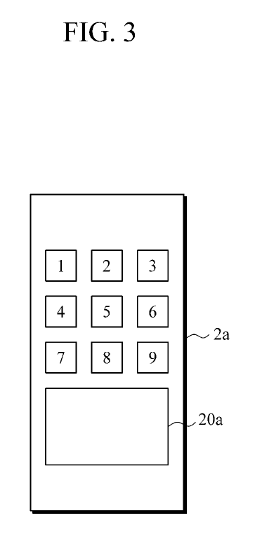

FIG. 3 illustrates an example an exterior of the apparatus 2a shown in FIG. 1.

Referring to FIGS. 1 and 3, the apparatus 2a may be a remote control. The remote control may be equipped with a sensor 20a. As illustrated in FIG. 3, the sensor 20a may be disposed somewhere on the exterior of the casing, such as a top or bottom surface of the remote control casing. The remote control with the sensor 20a may analyze a motion pattern of a user that is detected by the sensor 20a and transmit a signal to the electronic device to cause the electronic device to execute an operation corresponding to the analyzed motion pattern of the user. The motion pattern may be analyzed according to previously standardized signage. In this example, the user can use not only the functionality of buttons on a general remote control but also user-oriented functionality. The apparatus 2a may remotely control the electronic device 1 by transmitting radio signals to the electronic device 1.

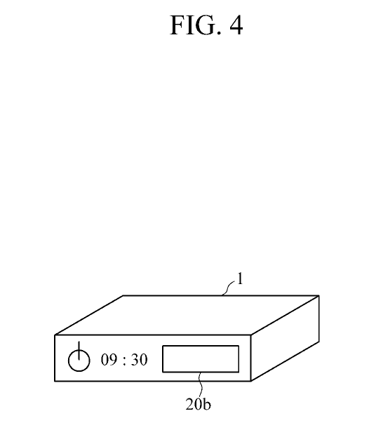

FIG. 4 illustrates an example of an exterior of the apparatus 2b of FIG. 2.

Referring to FIGS. 2 and 4, the apparatus 2b may be mounted in the electronic device 1. As another example, the apparatus 2b may be connected to the electronic device 1 by a wire. When the apparatus 2b is mounted inside the electronic device 1, the sensor 20b may be exposed from a lower surface of the electronic device 1 to detect an input motion of the user, as shown in FIG. 4. It should be appreciated that the location of the sensor 20b may be at any desirable position.

In the example of FIGS. 2 and 4, the apparatus 2b may be removed from the electronic is device 1. For example, the apparatus 2b may be used to control the electronic device 1 while attached to the electronic device 1. Also, the apparatus 2b may be removed and used remotely to control the electronic device 1. Thus, the apparatus 2b may be attachable/detachable.

Generally, the electronic device may have channel-up/down buttons and volume-up/down buttons on its lower portion. In this case, it may be difficult to associate all instructions required for controlling the electronic device with the buttons provided on the electronic device. According to various aspects, the apparatus 2b analyzes a user's motion pattern detected by the sensor 20b arranged on the surface of the electronic device 1 and controls the electronic device 1 to execute an instruction corresponding to the analyzed motion pattern of the user.

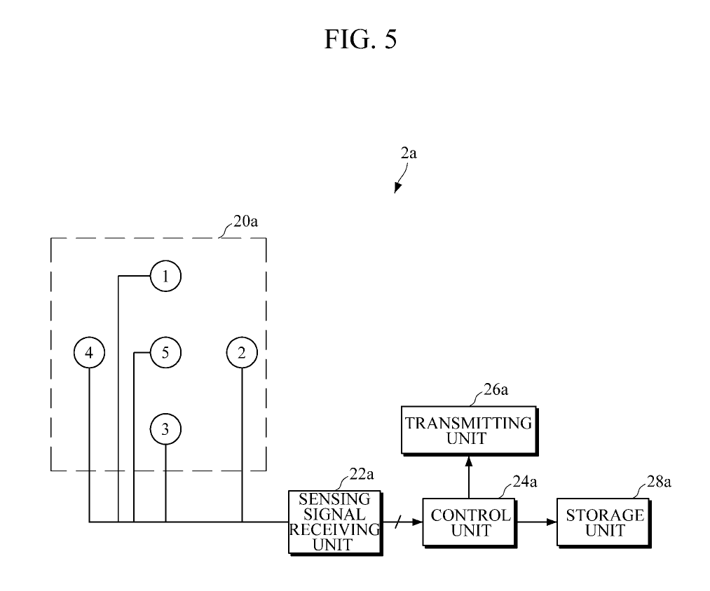

FIG. 5 illustrates an example of the apparatus 2a of FIG. 1.

Referring to FIGS. 1 and 5, the apparatus 2a includes a plurality of sensors 20a, a sensing signal receiving unit 22a, a control unit 24a, a transmitting unit 26a, and a storage unit 28a.

The plurality of sensors 20a may detect manipulations by a user. The locations of the sensors 20a may vary. For example, sensors \textcircled{1}, \textcircled{2}, \textcircled{3}, \textcircled{4}, and \textcircled{5} may be arranged on the top, right, bottom, left and/or central portions of a surface of the apparatus 2a, as shown in FIG. 5.

In this example, a predetermined number of sensors 20a may be configured in various forms for sensing user manipulations. For example, the sensors 20a may be small and thin-layered, unlike a general touch screen that is manufactured by disposing an additional glass or conductive layer on a touch panel that detects a touch position.

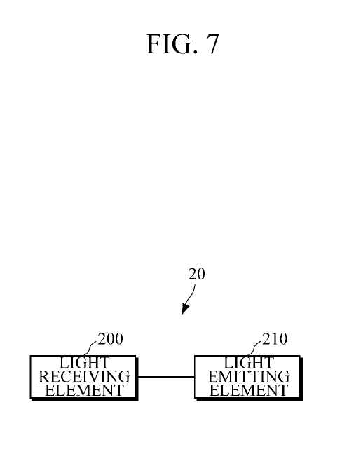

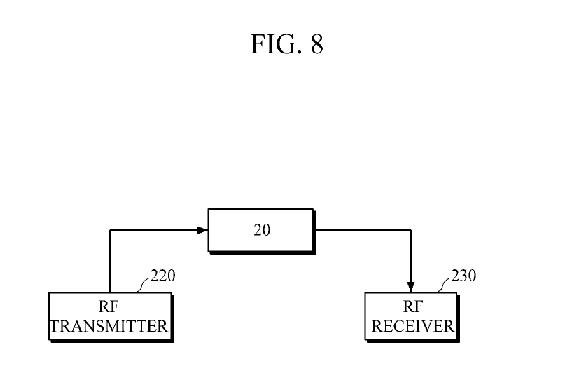

The plurality of sensors 20a may be aligned in a touch area in which light emitting elements and light receiving elements are integrated with each other to detect manipulation by a user, an example of which is described with reference to FIG. 7. As another example, the plurality of sensor 20a may detect a user's manipulation by means of radio frequency (RF) signals transmitted between an RF signal transmitter and an RF signal receiver, an example of is which is described with reference to FIG. 8. As another example, the plurality of sensors 20a may be motion detection sensors. In this example, the sensors 20a may accurately detect all orientations, postures and acceleration in all directions. The plurality of sensors 20a may be gravity sensors.

The sensing signal receiving unit 22a may receive user manipulation signals generated by the sensors 20a. The control unit 24a may recognize the motion pattern of the user manipulation from the user manipulation signals received from the receiving unit 22a, and may determine an operation to be executed in accordance with the recognized user's motion pattern. For example, the control unit 24a may confirm the user manipulations detected by the sensors 20a, obtain location values of the sensors 20a, recognize the user's motion pattern based on the location values, and determine an operation to be executed from among predefined operations, in accordance with the recognized motion pattern.

In response to confirming that the sensors have detected the user manipulation, the control unit 24a may arrange the location values of the confirmed sensors sequentially in the order of detection, compare the location values with a predefined motion pattern to find motion patterns that have motion orders that match with the location values, and select one from the found motion patterns.

For example, referring to FIG. 5, in response to at least one sensor detecting a user manipulation, the control unit 24a may arrange location values of the detection-confirmed sensors sequentially in the order that the sensors detect the user's manipulations. For example, if the order of the sensors is \textcircled{1}→\textcircled{2}→\textcircled{3}, the corresponding user's motion pattern may be “ [symbol] ”.

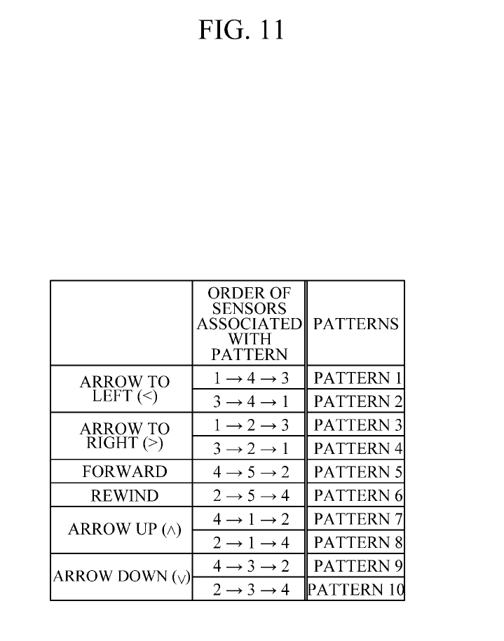

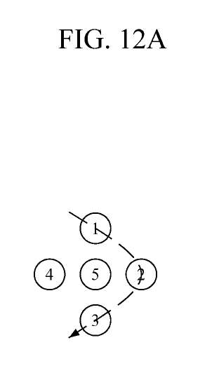

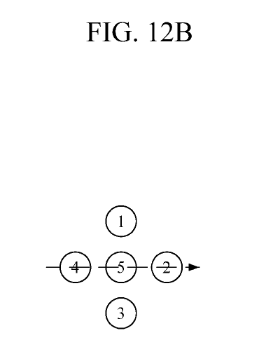

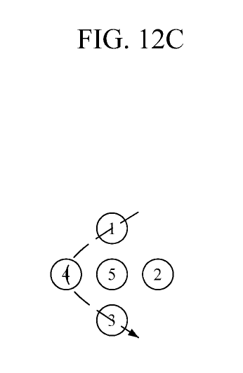

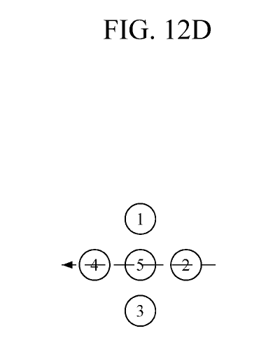

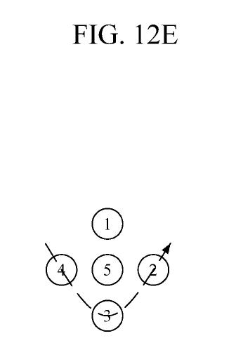

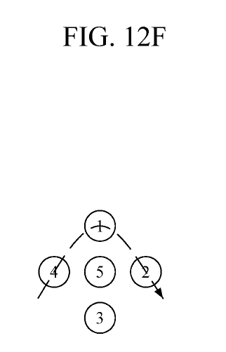

For example, if the motion pattern recognized from the user manipulations detected by the sensors 20a is “ [symbol] ,” the control unit 24a may determine an operation such as fast forwarding content or play back the final content. As another example, if the motion pattern is “ [symbol] ,” the is control unit 24a may determine an operation such as rewinding to the beginning of content or playing back the first content. As another example, if the motion pattern is “—” in a right-hand direction, the control unit 24a may determine an operation such as fast forwarding or playing back the next content. If the motion pattern is “—” in a left-hand direction, the control unit 24a may determine an operation as fast rewinding or playing back a previous content. If the motion pattern is “ [symbol] ,” the control unit 24a may determine an operation such as turning the volume or channel up. Likewise, if the motion pattern is “ [symbol] ,” the control unit 24a may determine an operation such as turning the volume or channel down. Examples of determining of an operation based on a recognized motion pattern of the user is described with reference to FIGS. 11 and 12.

The transmitting unit 26a may transmit a digital signal to the electronic device 1 to control the electronic device 1 to execute the determined operation. The storage unit 28a may store information about operations associated with various motion patterns, in advance. The stored information may be used when the control unit 24a determines an operation corresponding to a user's motion pattern. In addition, the storage unit 28a may store location values of the respective sensors that detect manipulation by the user.

FIG. 6 illustrates an example of the apparatus 2b of FIG. 2.

Referring to FIGS. 2 and 6, the apparatus 2b equipped in the electronic device 1 may include a plurality of sensors 20b, a sensing signal receiving unit 22b, a control unit 24b, an executing unit 26b, and a storage unit 28b.

The plurality of sensors 20b may detect user's manipulations. The locations of the sensors may vary. For example, sensors \textcircled{1}, \textcircled{2}, \textcircled{3}, \textcircled{4}, and \textcircled{5} may be arranged on the upper, right, lower, left and/or central portions of one surface of the apparatus 2b, as shown in FIG. 6.

In this example, a predetermined number of sensors 20b may be configured in various is forms for sensing user's manipulations. The configurations of the sensing signal receiving unit 22b, the control unit 24b and the storage unit 28b correspond to those of the sensing signal receiving unit 22a, the control unit 24b and the storage unit 28a which are illustrated in FIG. 5. The executing unit 26b may execute an operation determined by the control unit 24b.

FIG. 7 illustrates an example of a sensor using light.

Referring to FIG. 7, a plurality of sensors may be arranged on a touch area in which a light emitting element 210 and a light receiving element 200 are integrated with each other to detect manipulation by a user. For example, the light emitting element 210 and the light receiving element 200 may be disposed on the same substrate. This example is different from a general touch screen which has an additional glass or conductive layer on a touch panel, because the sensor shown in FIG. 7 uses the integrated light emitting and receiving elements. Accordingly, it is possible to manufacture small and thin-layered sensors.

FIG. 8 illustrates an example of a sensor using an RF signal.

Referring to FIG. 8, a plurality of sensors may detect manipulation by a user based on RF signals transmitted between an RF transmitter 220 and an RF receiver 230. For example, if an RF signal transmitted from the RF transmitter 220 through an antenna is reflected from a surface of the sensor due to the user's manipulation on the sensor, the RF receiver 230 receives the reflected RF signal.

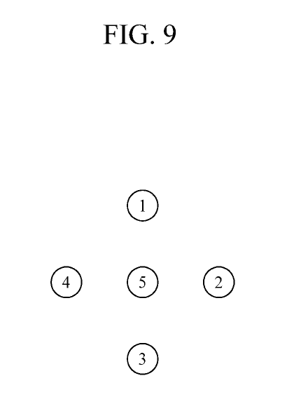

FIG. 9 illustrates an example of an arrangement of a plurality of sensors.

Referring to FIG. 9, unlike a touch screen which utilizes the entire surface of a substrate as a touch area, a given number of sensors are arranged in a predefined touch area. For example, as shown in FIG. 9, touch sensors may be located at the left, right, top, bottom and central portions of the touch area, respectively. However, the disposition of the sensors described above is provided only for the purpose of example, and the sensors may be disposed in various ways.

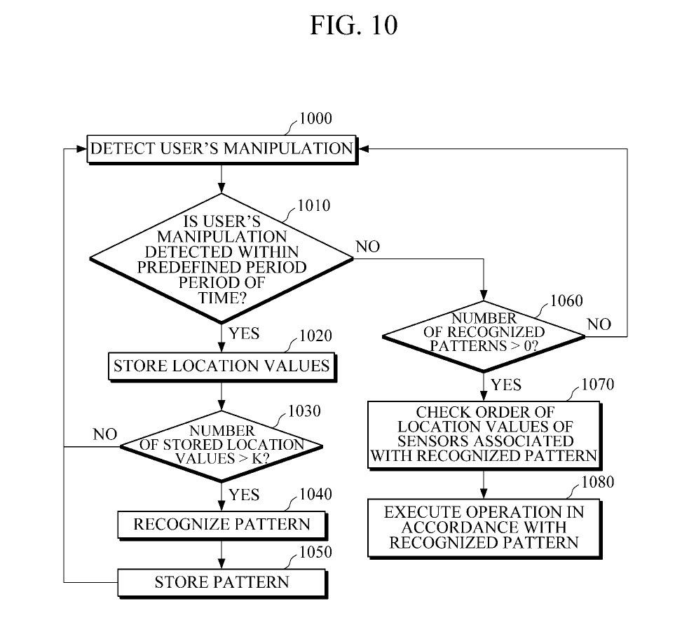

FIG. 10 illustrates an example of a method for controlling an electronic device.

The method of FIG. 10 may be performed by an apparatus that confirms user manipulations detected by a plurality of sensors, obtains location values of the sensors whose detection of user's manipulations is confirmed to recognize a user's motion pattern based on the obtained location values of the sensors, and determines an operation to be executed in accordance with the recognized user's motion pattern. Then, the apparatus executes the determined operation or transmits a signal for the electronic device to execute the determined operation.

Referring to FIG. 10, in response to a plurality of sensors detecting manipulation by a user, in 1000, the apparatus determines whether the user manipulations are detected within a predefined period of time, in 1010. In response to determining that the manipulations are detected within a predefined period of time, the apparatus stores location values of the confirmed sensors, in 1020. Thereafter, whether the number of stored location values is greater than k is determined, in 1030. K may be a natural number, for example, 3. In response to the number of stored location values being greater than k, the apparatus recognizes the motion pattern of the user based on the location values of the sensors in 1040, and stores the recognized motion pattern in 1050.

In contrast, if manipulations by the user are not detected within a predefined period of time in 1010, whether or not there is at least one recognized pattern is determined in 1060. In response to at least one recognized pattern being determined, the order of location values of the sensors associated with each of the recognized pattern are determined, in 1070, and the apparatus executes an operation corresponding to the recognized pattern or transmits a signal for the is electronic device to execute the operation, in 1080.

FIG. 11 is a table that illustrates examples of motion patterns recognized based on user manipulations detected by a plurality of sensors for controlling an electronic device and operations corresponding to the motion patterns. FIGS. 12A to 12F are diagrams illustrating examples of the motion patterns associated with location values of the sensor according to the table shown in FIG. 11.

Referring to FIGS. 9, 11 and 12A to 12F, if a user's motion pattern is “ [symbol] ”, that is, if the order of the location values of the sensors associated with the recognized motion pattern is \textcircled{1}→\textcircled{2}→\textcircled{3} (refer to FIG. 12A) or \textcircled{3}→\textcircled{2}→\textcircled{1}, the apparatus may determine to fast forward to the end of content or play back the final content. For example, the electronic device may move to the end of a video or display the final picture. As another example, if a user's motion pattern is “ [symbol] ,” that is, if the order of the location values of the sensors associated with the recognized motion pattern is \textcircled{1}→\textcircled{4}→\textcircled{3} (refer to 12C) or \textcircled{3}→\textcircled{4}→\textcircled{1}, the apparatus may determine to rewind to the beginning or playing back the first content. For example, the electronic device may move to the beginning of a video or display the first picture.

As another example, if a motion pattern is “—” in a right-hand direction, that is, if the order of the location values of the sensors associated with the recognized motion pattern is \textcircled{4}→\textcircled{5}→\textcircled{2} (refer to FIG. 12B), the apparatus may determine to fast forward current content or play back the next content. For example, the electronic device may skip to a certain time point of a video or display the next picture. If a motion pattern is “—” in a left-hand direction, that is, if the order of the location values of the sensors associated with the recognized motion pattern is \textcircled{2}→\textcircled{5}→\textcircled{4} (refer to FIG. 12D), the apparatus may determine to rewind or play back the previous content. For example, the electronic device may skip back to a certain time point of video, or display a previous picture.

In another example, if a motion pattern is “ [symbol] ,” that is, if the order of the location values of the sensors associated with the recognized motion pattern is \textcircled{4}→\textcircled{3}→\textcircled{2} (refer to FIG. 12E) or \textcircled{2}→\textcircled{3}→\textcircled{4}, the apparatus may determine an operation as turning the volume or the channel down. If a motion pattern is “ [symbol] ,” that is, if the order of the location values of the sensors associated with the recognized motion pattern is \textcircled{4}→\textcircled{1}→\textcircled{2} (refer to FIG. 12F) or \textcircled{2}→\textcircled{1}→\textcircled{4}, the apparatus may determine an operation as turning the volume or channel up.

According to various aspects, provided is an apparatus and method for intuitively and easily controlling an electronic device using a user's motion pattern. For example, a user's motion pattern is recognized and an operation is executed corresponding to the recognized motion pattern. Accordingly, it is possible for a user to intuitively and easily input an instruction for executing an operation in an electronic device. In addition, because the user input is based on the recognition of a user's motion pattern, the user can conveniently use the apparatus.

Further, instead of a touch screen, a small number of sensors are provided to receive various motion inputs, thereby improving design efficiency of the apparatus and reducing its size. For example, the apparatus may include a light transfer medium incorporating both a light emitting element and a light receiving element or RF signal transfer units that are used for the sensors, so that the number of parts included in the apparatus is reduced, which leads to reduction in manufacturing costs.

While the examples herein refer to a remote control as the apparatus for controlling an electronic device, the descriptions herein are not limited thereto. For example, the plurality of sensors could be placed on pad, a surface, or on another device to be used to receive user input.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations is are within the scope of the following claims.

What is claimed is:

1. An apparatus for controlling an electronic device, the apparatus comprising:
a plurality of sensors configured to detect manipulation by a user;
a control unit configured to recognize a motion pattern based on the manipulations of the user detected by the plurality of sensors and determine an operation to be executed based on the recognized motion pattern; and
a transmitting unit configured to transmit a digital signal to the electronic device to control the electronic device to execute the operation determined by the control unit.

2. The apparatus of claim 1, wherein the plurality of sensors are arranged at a touch area of the apparatus in which a light emitting element and a light receiving element are integrated with each other.

3. The apparatus of claim 1, wherein the plurality of sensors are configured to detect the manipulation of the user based on radio frequency (RF) signals transmitted between an RF signal transmitter and an RF signal receiver.

4. The apparatus of claim 1, wherein the plurality of sensors are motion detection sensors.

5. The apparatus of claim 1, wherein the plurality of sensors are gravity sensors.

6. The apparatus of claim 1, wherein the plurality of sensors are located at a left, a right, a top, a bottom, and a central portion of a predefined area on a surface of the apparatus.

7. The apparatus of claim 1, wherein the control unit is configured to confirm which sensors from among the plurality of sensors detect the manipulation of the user, obtain location values of the sensors that confirm detection of the manipulation of the user, recognize the motion pattern of the user based on the location values of the sensors that confirm detection of the manipulation, and determine the operation to be executed from among predetermined operations based on the recognized motion pattern.

8. The apparatus of claim 7, wherein the control unit is configured to sequentially arrange the location values of the sensors that confirm detection of the manipulation in an order of a first to last sensor to detect the manipulation, search for a motion pattern that matches with the order of the arranged location values of the sensors by comparing the order of arranged location values of the sensors and predefined motion patterns, and select a corresponding motion pattern.

9. The apparatus of claim 8, wherein the control unit is configured to determine the operation to be executed is fast forwarding towards an end of content or playing back final content, in response to the corresponding motion pattern being “ [symbol] .”

10. The apparatus of claim 8, wherein the control unit is configured to determine the operation to be executed is rewinding towards a beginning of content or playing back first content, in response to the corresponding motion pattern being “ [symbol] .”

11. The apparatus of claim 8, wherein the control unit is configured to determine the operation to be executed is fast forwarding current content or playing back next content, in response to the corresponding motion pattern being “—” in a right-hand direction.

12. The apparatus of claim 8, wherein the control unit is configured to determine the operation to be executed is rewinding current content or playing back previous content in response to a user's recognized motion pattern being “—” in a left-hand direction.

13. The apparatus of claim 8, wherein the control unit is configured to determine the operation to be executed as turning a volume or a channel up, in response to the corresponding motion pattern being “ [symbol] .”

14. The apparatus of claim 8, wherein the control unit is configured to determine the is operation to be executed as turning a volume or a channel down, in response the corresponding motion pattern being “ [symbol] .”

15. An apparatus for controlling an electronic device, the apparatus comprising:
a plurality of sensors configured to detect manipulation of a user;
a control unit configured to recognize a motion pattern based on the manipulation of the user detected by the plurality of sensors and determine an operation to be executed based on the recognized motion pattern; and
an operation executing unit configured to execute the operation determined by the control unit.

16. A method of controlling an electronic device, the method comprising:
detecting manipulation of a user using a plurality of sensors;
recognizing a motion pattern based on the manipulation of the user detected by the plurality of sensors;
determining an operation to be executed based on the recognized motion pattern; and
transmitting a digital signal to an electronic device to control the electronic device to execute the determined operation.

17. The method of claim 16, wherein the determining comprises:
confirming which sensors from among the plurality of sensors detect the manipulation by the user,
obtaining location values of the sensors that confirm detection of the manipulation,
recognizing the motion pattern of the user based on the location values of the sensors that is confirm detection of the manipulation, and
determining the operation to be executed from among predetermined operations based on the recognized motion pattern.

18. The method of claim 17, wherein the recognizing of the motion pattern comprises checking whether a number of obtained location values of the sensors that confirm detection of the manipulation is greater than a predetermined value, and
in response to the number of obtained location values being greater than the predetermined value, recognizing the motion pattern based on the obtained location values of the sensors.

19. The method of claim 17, wherein the recognizing of the motion pattern comprises sequentially arranging the location values of the sensors that confirm detection of the manipulation in an order of a first sensor to a last sensor to detect the manipulation, and
searching for a motion pattern that matches with an order of the arranged location values of the sensors by comparing the order of arranged location values of the sensors and predefined motion patterns associated with orders of location values of the sensors and selecting a corresponding motion pattern.
